(19) United States
(12) Patent Application Publication
(10) Pub. No.: US 2002/0014513 A1
(43) Pub. Date: Feb. 7, 2002

(54) Soldering apparatus for through holes on surface mount printed circuit boards

(76) Inventors: Jess J. Baker, Colbert, WA (US); Alan J. Cable, Spokane, WA (US)

Correspondence Address: David S. Thompson, Symons Building #418, South 7 Howard, Spokane, WA, 99201, US

(21) Appl. No.: 09/920,563

(22) Filed: Jul. 31, 2001

Related U.S. Application Data
(60) Provisional application No. 60/222,122, filed on Jul. 31, 2000.

(51) Int. Cl. B23K 1/08; B23K 31/02; B23K 35/12

(52) U.S. Cl. 228/37; 228/260

(57) ABSTRACT

A soldering apparatus is adapted for making solder connections to through-hole technology components on substantially surface mount technology printed circuit boards. Lifter assemblies raise and lower solder pump assemblies. Solder pump assemblies in turn each support a nozzle support assembly. Each nozzle support assembly in turn supports either a nozzle assembly or a wave nozzle assembly. In operation, a nozzle assembly having a solder discharge configuration indicated by, and compatible with, the pin configuration of the component to be soldered is raised by the appropriate lifter assembly. Where no nozzle assembly is appropriate for the configuration of the component to be soldered, a wave nozzle assembly is raised, and the PCB moved into position adjacent to the wave nozzle assembly.

### CROSS-REFERENCES

This application is a continuation of a provisional application having Ser. No. 60/222,122 filed Jul. 31, 2000.

### BACKGROUND

The electronics industry has converted the bulk of the production of electronic circuit card from older through-hole technology to newer surface mount technology (SMT). A problem currently exists, however, where a printed circuit board has both through-hole and SMT technology. Where through hole soldering technology is used to solder components onto a fully loaded SMT board, massive damage would result without expensive protective fixtures. Conversely, if the through-hole components are soldered first, the heat of the SMT soldering process may damage the older through-hole components.

Through-hole technology uses generally larger components mounted on the top or bottom side of the printed circuit board. The components have electrically conductive leads that penetrate through the circuit board and are soldered from the opposite side of the board. Traditionally, the through hole technology utilized a wave soldering process where the circuit board, populated with all the components, was dragged through a wave of flux, then preheated to activate the flux, and then dragged through a wave of solder. The solder contacted 100% of the surface of the bottom of the circuit board, but remained and cooled only on the surfaces where the components were in contact to the actual printed circuit.

The SMT technology involves placing a pattern of solder paste (which usually is applied in a traditional silk screening method) onto the component side(s) of the printed circuit board. The components are then individually placed by high-speed machines onto the appropriate place on the pre-pasted printed circuit board. The board is then allowed to go through a reflow oven where it is brought up to temperature, thereby melting all of the solder paste to the circuit board and the components and forming the electrical connections. This technology allows for components to be soldered both sides of the circuit board, allowing for a much denser and more complex circuit than was possible with through hole technology.

A problem currently exists, however, where a printed circuit board has both through-hole and SMT technology. However, the current reality of engineering design dictates some through hole components still be incorporated into a substantially SMT circuit. Since the SMT components are already soldered in place, the problem is how to solder the through hole components without disturbing the SMT components. This process is called Selective Soldering.

In a mixed through-hole and SMT technology application, known manufacturing techniques provide only a few options by which a through hole component may be solder to the SMT board.

A first option is to use protective masks and fixturing that thermally and mechanically mask the area surrounding the area to be soldered in order to isolate the SMT components while the board is passed through the traditional wave soldering method. This technology is rapidly losing favor because of the extreme cost of the fixturing and the lead-time and design time to acquire the appropriate fixturing. There is also the ever-present danger of exposing the surface mount components to the solder in this process, which would cause them to reflow or move from position, typically destroying the printed circuit board and all components.

A second option, which is used more favorably in current traditional methods, is to incorporate a dip soldering technique where the printed circuit board is held in a fixture and moved in a ZY (vertical and horizontal) manner to a dedicated flux and solder nozzle that matched the specific pattern on the circuit board to be soldered. For example, where a 60 pin connector is to be soldered into place, a fixture (i.e. nozzle and supporting adapting hardware) configured to solder such a 60 pin connector is used. The advantage of this procedure is a definite isolation of the surface mount components with respect to the high temperature soldering operation and the lack of the requirement for specific tooling to mask and hold the circuit board during the soldering operation.

Unfortunately, the technology has serious drawbacks. First, the individual and specific fixtures and nozzles for the flux and soldering operations have proven to be very expensive. Second, the design and lead-time to manufacture the nozzles and associated fixtures cause circuit manufacturers to schedule production around the availability of new tooling. Third, there is considerable expense associated with the down time resulting from the tooling change-over and set-up of a new nozzle design for each soldering operation. Fourth, testing the newly configured fixtures additionally consumes resources, and typically results in permanent damage to a number of printed circuit boards sent through the process initially. And fifth, large keep away areas are required to prevent the solder from contacting adjacent SMT components.

An alternate way of accomplishing the forgoing is to use miniature wave soldering. The current state of the art however produces waves that are unstable and thus require large keepaway areas from adjacent surface mount components. A method of controlling the problem of unstable waves has been to pump the wave in a directed stream, thereby knowing its true position but now limiting the approach to the wave and still requiring large but known keep away areas. Another method to overcome this is to pump the wave to an extremely limited flow thereby gaining stability of the wave, but then reducing significantly the thermal transfer to the component to be soldered, limiting clearance between the solder nozzle and the component lead to be soldered, yet still requiring large keep away areas.

### SUMMARY

For the foregoing reasons, there is a need for a soldering apparatus that can solder through-hole technology components to a printed circuit board carrying a substantial quantity of surface mount technology components. First, the soldering apparatus should reduce or eliminate the design and lead time required to produce fixtures and tooling required to solder through-hole components to a new board design. Second, the soldering apparatus should eliminate the problem and expense of designing and obtaining custom fixtures and nozzles for the flux and soldering of through-hole technology components for each individual printed circuit board. Third, the soldering apparatus should reduce or eliminate the expense associated with the down time resulting from the tooling changeover and set-up of a new nozzle design for each soldering operation. Fourth, the soldering apparatus should eliminate the problem and expense of testing the newly configured fixtures, which typically results in permanent damage to a number of printed circuit boards initially sent through the process. And fifth, the soldering apparatus should enable the selective soldering of through-hole components while in very close proximity to adjacent SMT components.

The present invention is directed to an apparatus that satisfies the above needs. A novel soldering apparatus is disclosed that can solder through-hole technology components to a printed circuit board carrying a substantial quantity of surface mount technology components. The soldering apparatus reduces or eliminates the lead- time and costs required to produce fixtures and tooling required to solder through-hole components to a new board design. Similarly, the soldering apparatus reduces or eliminates the expense associated with the down time resulting from the tooling change-over and the permanent damage to printed circuit boards initially sent through the process during testing. Further the soldering apparatus enables soldering throughhole components while extremely close to adjacent components, typically 1 mm or less.

The soldering apparatus 100 of the present invention provides some or all of the following structures.

(A) A solder pot assembly 200 supports a quantity of solder 250 in a liquid state.

(B) A plurality of lifter assemblies 300 control the elevation of an associated solder pump assembly, nozzle support assembly 500 and either a nozzle assembly 600 or a wave nozzle assembly 700. At the appropriate time, i.e. in concert with a robotic apparatus moving the printed circuit board (PCB), the appropriate lifter assembly lifts its nozzle assembly into an elevated position. Due to the elevation, robotic apparatus is able to move the PCB into a position adjacent to the selected solder pump assembly without interference with adjacent nozzle assemblies.

Each lifter assembly includes a cam motor 310 that drives a camshaft 320. The camshaft carries an index wheel 324. The rotational movement of the index wheel is tracked by an opto device 326, thereby allowing precise control over the rotation of the camshaft. First and second lifter cams are carried by the cam drive shaft, respectively. The first and second lifter cams are associated with first and second cam followers, which in turn in turn are associated with first and second main pump lifters.

(C) A solder pump assembly 400 is carried by each lifter assembly 300. Each solder pump assembly supplies molten solder from the solder pot assembly through a nozzle support assembly to a nozzle assembly. First and second ends of each solder pump assembly are supported by the first and second main pump lifters of the associated lifter assembly. A portion of each solder pump assembly is carried within the solder pot assembly, allowing access to a quantity of molten solder.

Each solder pump assembly includes a motor 410 driving an impeller 434. The impeller supplies molten solder under pressure to a manifold 438.

(D) A nozzle support assembly 500 is attached to a nozzle base 440 on the upper surface of the manifold of each solder pump assembly. As a result, the nozzle support assembly moves up and down in response to the movement of the lifter assembly 300. Vertical passages, defined in the nozzle support assembly, allows liquid solder to travel to the nozzle assembly 600, and excess solder to return.

(E) Each nozzle assembly 600 is carried individually by a separate nozzle support assembly 500. Each nozzle assembly is typically different, and discharges solder in a pattern configured to solder an electronic component having a specific or non-specific form factor. As a result, a plurality of nozzle assemblies are associated with each solder apparatus 100, and a plurality of different electronic components may be soldered.

During operation, when the need to solder an electronic component having a particular form factor is indicated, the appropriate nozzle assembly is raised, and other non-indicated nozzle assemblies lowered. As seen above, control over the plurality of lifter assemblies allows each nozzle assembly to be raised or lowered as appropriate. When the appropriate nozzle assembly is in the raised position, robotic elements can position the portion of the circuit board to be soldered in direct contact with solder exhausted by that nozzle assembly.

(F) During operation, an electronic component may be present having a form factor not corresponding to any of the nozzles 600 carried by the nozzle support assemblies. In this circumstance, a wave point nozzle assembly 700, also carried by a nozzle support assembly, may be used to solder the component to the printed circuit board.

The wave point nozzle assembly 700 includes concentrically arrayed and vertically oriented outer and inner pipes 720, 740. A Nitrogen passage 722 is defined between the pipes, while a solder passage 742 is defined within the inner pipe. An outer nozzle enclosure 760, carried by an upper end of the outer pipe, has cone shaped sidewalls 766 which tend to direct the heated Nitrogen toward the location to be soldered. The Nitrogen elevates this location's temperature and surrounds it with a non-reactive atmosphere during the soldering operation. An inner nozzle 780, carried by an upper end of the inner pipe, discharges a rounded nipple-shaped wave of solder which remains constant in shape, orientation and size, with minimum- flicker or movement. The robotic elements of the soldering apparatus then move the exact portion of the printed circuit board to be soldered into contact with the tip of the solder wave.

It has been found that a nozzle constructed of a solder wettable material such as iron, nickel, stainless and others produce a wave of enhanced stability, while aiding in the controlled draining and return of the solder wave to the solder reservoir.

It is therefore a primary advantage of the present invention to provide a novel soldering apparatus for through hole components on a substantially surface mount technology printed circuit board which:

(1) reduces or eliminates the design and lead time required to produce fixtures and tooling required to solder through hole components to a new board design;

(2) eliminates the time and expense of designing and obtaining custom fixtures and nozzles for the flux and soldering of through hole technology components for each individual printed circuit board;

(3) reduces or eliminates the expense associated with the down time resulting from the tooling change-over and set-up of a new nozzle design for each soldering operation; and

(4) eliminates the problem and expense of testing the newly configured fixtures, which typically results in permanent damage to a number of printed circuit boards initially sent through the process.

(5) Eliminates large keep away areas between the leads soldered and adjacent SMT components.

A further advantage of the present invention is to provide a novel soldering apparatus for through hole components on a substantially surface mount technology printed circuit board which provides a wave point solder fixture which is able to solder components to a board without the need for a specialized nozzles, fixtures and tooling, and without the need to design, purchase, install and test such fixtures.

Other objectives, advantages and novel features of the invention will become apparent to those skilled in the art upon examination of the specification and the accompanying drawings.

### DRAWINGS

These and other features, aspects, and advantages of the present invention will become better understood with regard to the following description, appended claims, and accompanying drawings where:

FIG. 1 is a orthographic plan view of a version of the soldering apparatus. In this version, a solder pot assembly is seen, along with six lifter assemblies, each carrying an associated solder pump assembly, nozzle support assembly and nozzle assembly.

FIG. 2 is a side orthographic view of the soldering apparatus of FIG. 1, showing the ends of the six lifter assemblies, and in particular showing two of the lifter assembles elevating their associated nozzle support and nozzle assemblies.

FIG. 3 is cross-sectional view of the soldering apparatus of FIG. 1, showing particularly how the nozzle assembly, nozzle support and solder pump assemblies are each carried by a lifter assembly, and showing how portions of the solder pump and nozzle support assemblies extend into the solder pot assembly.

FIG. 4 is a view similar to that of FIG. 3, showing one of the six lifter assemblies removed from the other assemblies for clarity.

FIG. 5 is a view similar to that of FIG. 4, but showing a plan orthographic view of the lifter assembly.

FIG. 6 is an end orthographic view of the lifter assembly of FIG. 4.

FIG. 7 is a view similar to that of FIG. 3, showing one of the six solder pump assemblies removed from the other assemblies for clarity.

FIG. 8 is an orthographic plan view of the pump assembly of FIG. 7.

FIG. 9 is an end orthographic view of the pump assembly of FIG. 7.

FIG. 10 is an orthographic view similar to that of FIG. 3, showing the solder pump assembly, nozzle support assembly wave nozzle assemblies, and also illustrating how the lifter assembly raises and lowers these assemblies during operation.

FIG. 11 is an enlarged view of portions of the solder pump assembly, the nozzle support assembly and the wave point nozzle assembly.

FIG. 12 is a much-enlarged cross-sectional view of the wave point nozzle assembly.

### DESCRIPTION

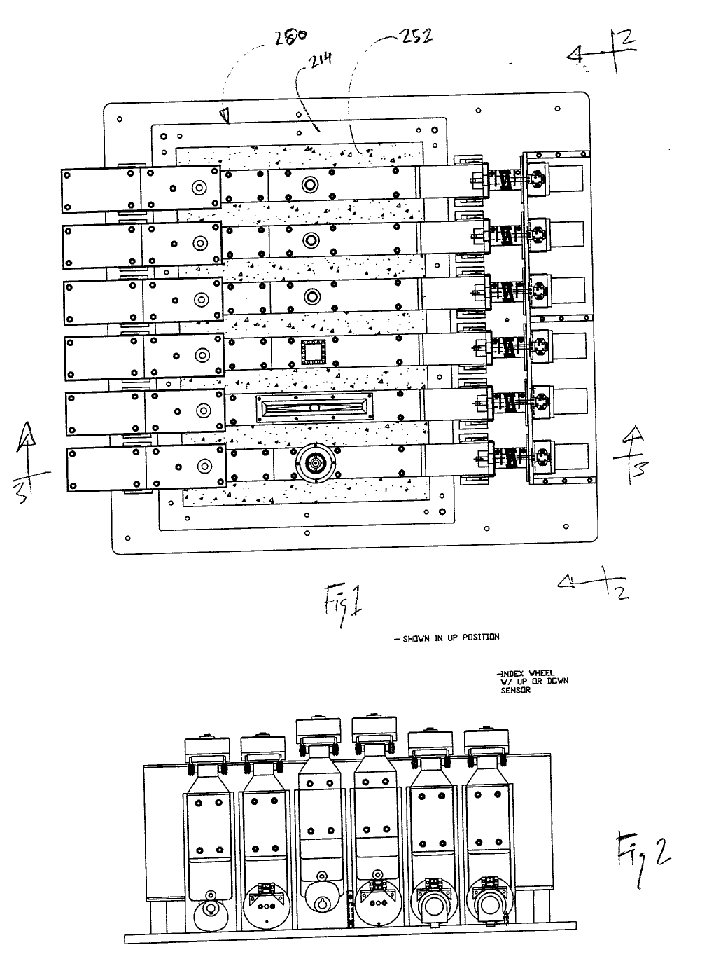

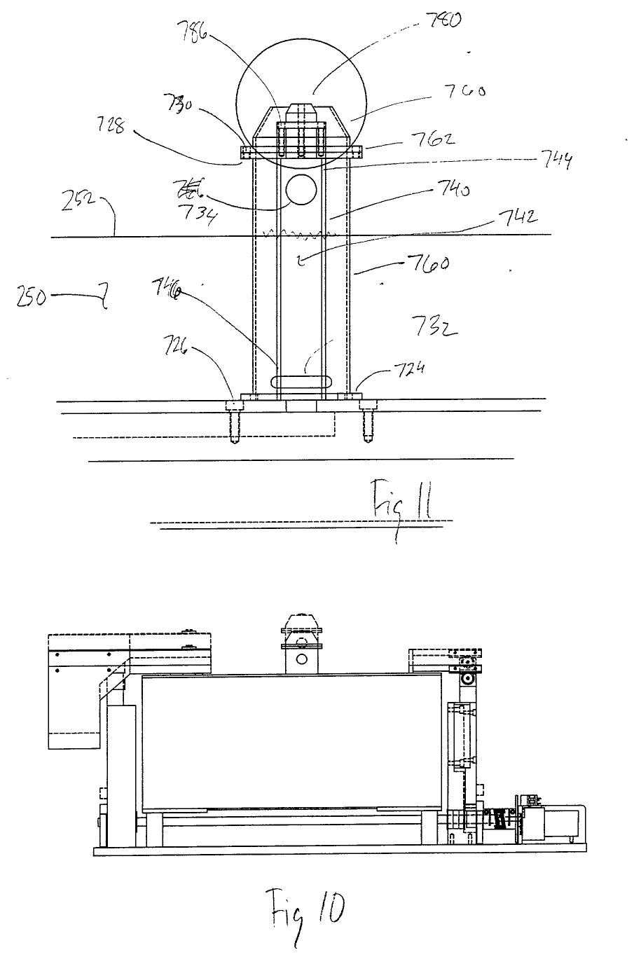

Referring in generally to FIGS. 1 through 10, a soldering apparatus 100 for the soldering of through hole technology components on substantially surface mount technology printed circuit boards (PCBs) constructed in accordance with the principles of the invention is seen. A solder pot assembly 200 typically contains approximately 450 pounds of molten solder. Six lifter assemblies 300 raise and lower six solder pump assemblies 400. The solder pump assemblies in turn each support a nozzle support assembly 500. Each nozzle support assembly in turn supports either a nozzle assembly 600 or a wave nozzle assembly 700.

In a method of operation, a nozzle assembly having a solder discharge configuration indicated by, and compatible with, the pin configuration of the component to be soldered is raised by the appropriate lifter assembly 300. Similarly, the other nozzle assemblies are retained in, or moved to, the lowered orientation by their respective lifter assemblies. Robotic elements move the component to be soldered to a position adjacent the raised nozzle assembly, allowing the soldering connection to be made. Other locations on the board having the same soldering configuration requirements are then moved into position, and the soldering connections made. The raised nozzle is then lowered, and a second nozzle assembly having a solder discharge configuration indicated by, and compatible with, the pin configuration of a further component to be soldered is raised by the appropriate lifter assembly 300. Where no nozzle assembly is appropriate for the configuration of the component to be soldered, the wave nozzle assembly 700 is raised, and the PCB moved into position adjacent to the wave nozzle assembly.

A preferred solder pot assembly 200 supports a quantity of approximately 450 pounds of solder 250 in a molten state. A preferred solder pot assembly provides conventional heating elements to maintain the solder temperature at the desired level, and may include insulation in the sidewalls 210 and bottom 212.

The number of lifter assemblies 300, solder pump assemblies 400, nozzle support assemblies 500 and nozzle assemblies 600 are associated in a one-to-one relationship, i.e. they are associated in a “set,” wherein each set includes one of each assembly. For example, in the preferred embodiment illustrated, six of each such assembly is present. (However, in the preferred embodiment, only five nozzle assemblies 600 are provided, due to the inclusion of one wave nozzle assembly 700.)

Alternatively, a number other than six of each assembly could be provided. However, it is generally the case that additional “sets” of assemblies have diminishing marginal value. This is because a small number of nozzle assemblies are compatible with the pin configurations of a large number of through hole technology components. In contrast, a large number of nozzle configurations are compatible with only a small number of such components. Because of this and reasons of cost, it is generally preferable to include only those nozzle assemblies that are compatible with the pin configurations of a large number of through hole technology components.

Where a component to be soldered has a pin configuration that is inconsistent with the discharge configurations of the nozzle present, the wave point nozzle assembly 700 is used.

As seen in the orthographic plan view of FIG. 1, the preferred embodiment of the soldering apparatus 100 provides six lifter assemblies 300. Each lifter assembly raises and lowers an associated solder pump assembly 400, nozzle support assembly 500 and nozzle assembly 600 or wave nozzle assembly 700. The lifter assembly raises and lowers the supported nozzle assembly 600 or 700 in response to the need to solder a through hole technology electronic component having a pin configuration indicated by the solder discharge configuration of the supported nozzle 600. The range of motion of each lifter assembly is typically only several inches. The range of motion is determined by the clearance needed between the printed circuit board (PCB) and the robotic elements supporting it, which are vertically higher, and the nozzle assemblies not currently being used, which are vertically lower.

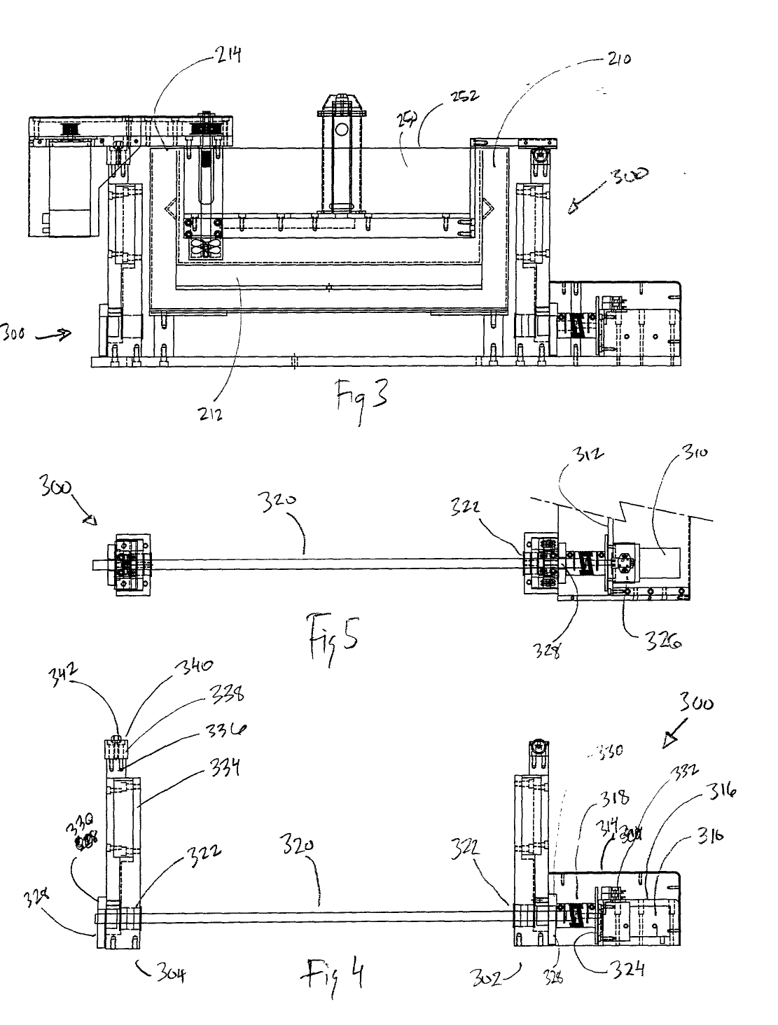

Referring generally to FIGS. 3 through 6, and in particular to FIG. 3, it can be seen that first and second ends 302, 304 of each lifter assembly lifts first and second ends 402, 404 of an associated solder pump assembly 400. Turning in particular to FIG. 4, it can be seen that each lifter assembly 300 includes a cam motor 310. The cam motor is carried by a cam motor mount 312, which in turn is carried by a cam motor mount support 316. A cam motor cover 314 encloses the cam motor.

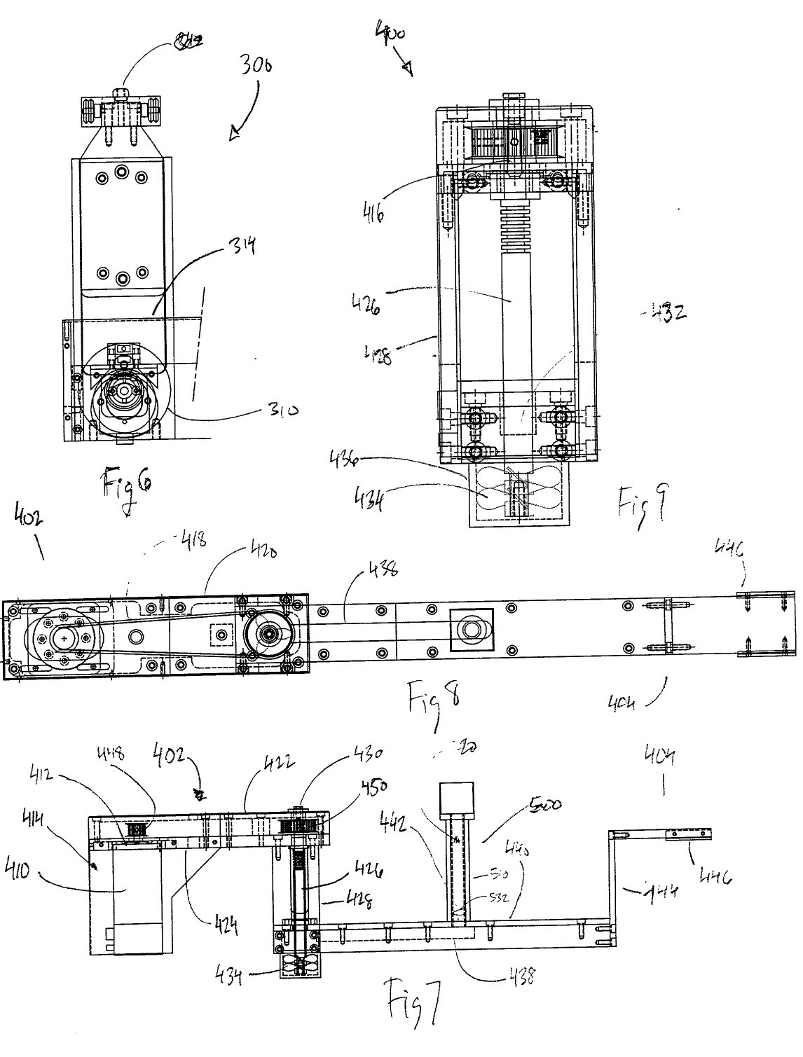

The drive shaft extending from the cam motor drives a cam coupler 318, which in turn drives a camshaft 320. As can be seen in both FIGS. 4 and 5, a camshaft bearing 322 supports first and second ends of the camshaft.

The camshaft carries an index wheel 324. An opto device 326 tracks the rotational movement of the index wheel. Feedback from the opto device to a controller circuit operating the cam motor 310 allows precise control over the rotation of the camshaft. As a result, the exact position of a lobe extending from the lifter cam 328 may completely known at all times. In a similar manner, the exact elevation of the follower cam 330, and by extension, the exact elevation of the solder pump assembly 400, nozzle support assembly 500 and nozzle assembly 600 is known and can be precisely controlled.

Referring particularly to FIGS. 3 and 4, first and second lifter cams 328 are carried by first and second ends of the camshaft 320, respectively, whereby rotation of the camshaft causes rotation of the lifter cams 328. Due to this arrangement, the lobes extending from each lifter cam move in concert. The first and second lifter cams are in contact with first and second cam followers 330 that move vertically in response to the rotary motion of the lifter cams. A cam cover and cam cover mount 332 typically enclose all of the cams.

In operation, rotation of the lifter cams 328 results in the vertical movement by the lifter cams and upper portions of the lifter assembly 300. As seen above, the elevation of the upper portions of the lifter assembly is a function of the orientation of the cams 328, and is controlled by feedback from the opto device 326.

Referring particularly to FIG. 4, the structure of the upper portion of the lifter assembly can be seen. While alternative hardware configurations could be devised, the preferred embodiment is illustrated. The first and second pump lifter supports 334 are associated with the first and second ends 302, 304 of the lifter assembly 300, and move in response to the first and second follower cams, to which they are attached. The first and second pump lifter supports carry first and second main pump lifters 336, respectively. A nesting pin plate 338, V-wheel yoke 340 and a nesting pin 442, or similar hardware, are carried by each main pump lifter 336, and provide the connection to the first and second ends of the solder pump assembly 400.

As seen in FIG. 1, in a preferred embodiment of the invention, six solder pump assemblies 400 are present. A lifter assembly 300 carries each solder pump assembly, and in turn, each solder pump assembly carries a nozzle support assembly 500. In operation, each solder pump assembly 400 supplies molten solder 250 from the solder pot assembly 200 through a nozzle support assembly 500 to a nozzle assembly 600. Referring particularly to the cross-sectional view of FIG. 3, it can be seen that a portion of each solder pump assembly is carried submerged within the solder pot assembly 200, allowing access to a quantity of molten solder.

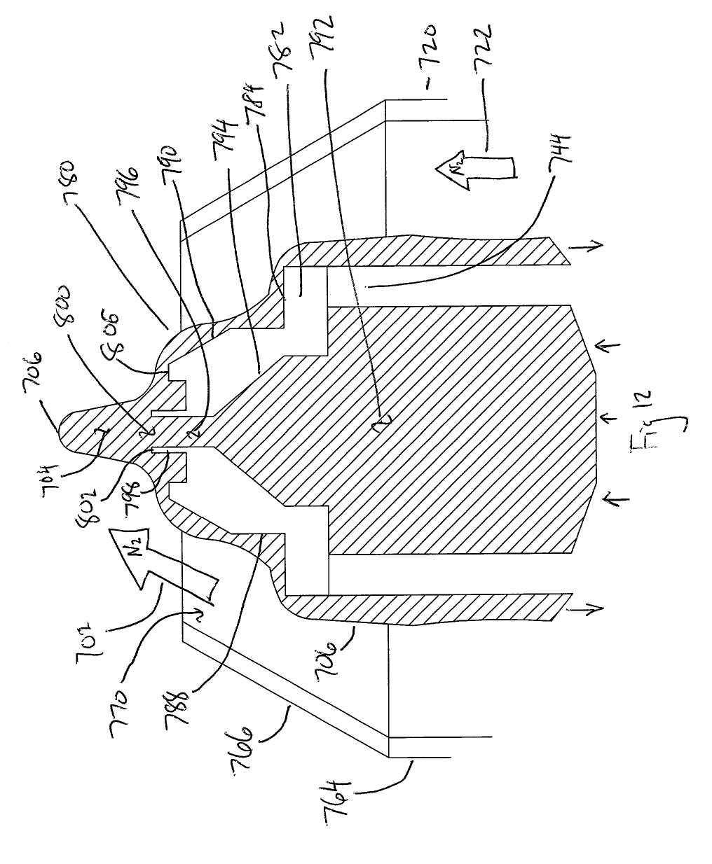

As seen in FIGS. 3 and 10, first and second ends 402, 404 of a solder pump assembly 400 are carried by the main pump lifters 336 of the first and second ends 302, 304 of a corresponding lifter assembly 300. In particular, the main pump lifter 336 carried by the first end 302 of the lifter assembly attaches to the first end 402 of the solder pump assembly at a support surface 424 defined on a lower portion of the belt enclosure. Similarly, the main pump lifter carried by the second end 304 of the lifter assembly attaches to the second end 404 of the solder pump assembly at a horizontal support 446. The horizontal support extends perpendicularly from an upper edge of a vertical support 444 carried by the second end of the nozzle base 440.

Each solder pump assembly includes a motor 410 carried by a motor mount 412 and enclosed by a motor cover 414. The motor drive shaft turns within a motor shaft bearing 416 and drives first belt support wheel 448. A drive belt 418 is carried horizontally between the first and second belt support wheels 448, 450. The drive belt is protected by an enclosure 420, having a removable cover 422, which allows the belt, bearings and drive wheels to be serviced.

Rotation of the second belt support wheel drives the impeller shaft 426. The impeller shaft is oriented vertically within the impeller shaft enclosure 428, and is supported at upper and lower ends by upper and lower bearings 430, 432.

In operation, the impeller 434 is submerged within the liquid solder, and is driven by the impeller shaft. An impeller tube 436 encloses the impeller blade, and tends to direct the flow of molten solder driven by the impeller into the solder supply manifold.

The solder supply manifold 438 is attached to the lower surface of the nozzle base 440. A solder supply orifice 442, defined within the nozzle base, allows solder to exit the manifold and move into the nozzle support assembly 500.

Referring particularly to FIG. 7, a nozzle support assembly 500 supports, and supplies solder to, each nozzle assembly 600. In operation, solder is supplied to the nozzle assembly through an inner tube 540. The overflow from the nozzle is returned to the solder pot assembly 200 through a channel 502 defined between the inner and outer tubes.

The nozzle support assembly 500 is attached to an upper surface of the nozzle base 440 of each solder pump assembly 400. As a result, during operation, the nozzle support assembly and nozzle assembly move up and down with the solder pump assembly 400 in response to the movement of the lifter assembly 300.

As seen in FIG. 3, in a preferred application, the nozzle support assembly 500 includes vertically oriented and concentrically arrayed outer and inner tubes 520, 540. Both the inner and outer tubes are attached to the solder pump assembly. The inner tube is attached to a hole defining the solder supply orifice 442 in the nozzle base 440. One manufacturing option for attachment of the inner tube to the solder pump assembly includes press-fitting the lower end of the inner tube into a solder supply orifice 422 defined in the nozzle base 440 of the solder pump assembly 440. A number of alternative construction techniques are available, all of which could result in a solder-tight seal between the nozzle support assembly and the solder supply manifold 438. With any manufacturing technique, solder is delivered from the manifold 438 through the inner tube 540 to the nozzle assembly 600.

Each nozzle assembly 600 is carried individually by a separate nozzle support assembly 500. Each nozzle assembly is typically different, and discharges solder in a pattern configured to solder an electronic component having a specific form factor or pin configuration. As a result, a plurality of nozzle assemblies is associated with each solder apparatus 100, and a plurality of different electronic components may be soldered.

During operation, when the need to solder a particular electronic component form factor is indicated, the appropriate nozzle assembly is raised, and other non-indicated nozzle assemblies lowered. Control over the various lifter assemblies 300 allows each nozzle assembly to be raised or lowered as appropriate. When the appropriate nozzle assembly is in the raised position, robotic elements can position the portion of the circuit board to be soldered in direct contact with solder exhausted by that nozzle assembly.

A generalized nozzle assembly 600 is of conventional construction, having a housing 610 defining an upwardly oriented discharge port 612. In operation, solder supplied to the nozzle assembly by the inner tube 540 of the nozzle support assembly is discharged by a port 612 having a configuration indicated by a the pin pattern of a component to be soldered. Once discharged, some of the solder adheres to the printed circuit board. However, the majority of the solder travels downwardly through the channel 502 defined between the inner and outer tubes 540, 520 of the nozzle support assembly, and is exhausted into the solder pot assembly 200 through solder exit opening 532 defined in a lower portion of the outer tube.

The nozzle assembly 600 could be of conventional construction, but a site specific nozzle could also embody the same features as the (round) wave nozzle, i.e. a shoulder surrounding the exhaust of the solder that would offer a bell shape even though it could be rectangular or square and a solder wettable material of construction.

The wave nozzle assembly 700 may used in place of a conventional technology nozzle assembly 600. In a preferred application, one of the six nozzle assemblies is a wave nozzle assembly; the other five are conventional nozzle assemblies selected for the likelihood of correspondence to the pin configurations of components to be soldered.

During operation, an electronic component may be present having a form factor, i.e. a pin configuration, not corresponding to any of the nozzles 600 carried by the nozzle support assemblies. In this circumstance, a wave point nozzle 700, also carried by a nozzle support assembly, may be used to solder the component to the printed circuit board.

When used, the wave nozzle assembly solders each pin of the component in turn. As a result, the soldering process is slower than in the circumstance where a nozzle assembly 600 is custom-designed for the component. However, where no available custom designed nozzle assembly 600 is available, the wave nozzle assembly 700 is an effective tool.

Referring particularly to FIGS. 10 through 12, a preferred version of the wave nozzle assembly 700 may be understood. The wave point nozzle assembly 700 includes concentrically arrayed and vertically oriented outer and inner pipes 720, 740. Nitrogen movement 722 between the pipes transfers heated Nitrogen upwardly, where it is discharged through the Nitrogen discharge opening 768 of the outer nozzle enclosure 760. A solder passage 742 is defined within the inner pipe, and allows solder to move upwardly to the inner nozzle 780. Excess solder 706, not used in making a solder connection, moves downwardly between the inner and outer pipes, where it is discharged through the solder exit opening 732 defined in the outer pipe.

Referring particularly to FIG. 11, the construction of a preferred version of the outer pipe 720 may be understood. A lower base 724 of the outer pipe is attached by a fastener 726 or other mechanism to the upper surface of the nozzle base 440 of the solder pump assembly 400. An upper end of the outer pipe defines a flange 728 or other structure which allows attachment to the outer nozzle enclosure 760 by means of fasteners 730 or similar structures. A solder exit opening 732 allows excess solder 706 which has moved downwardly, between the inner and outer pipes, to pass from the outer pipe and to thereby rejoin solder in the reservoir of the solder pot assembly 200. The solder exit opening 732 is typically defined in a lower portion of the outer pipe that is below the solder surface 252.

A Nitrogen input orifice 734 allows a source of compressed, heated Nitrogen to be injected into the outer pipe 720. As a result, a Nitrogen flow 722 moves up the passage between the inner and outer pipes, and results in a Nitrogen flow 702 discharged from the opening 768 in the outer nozzle enclosure 760.

Continuing to refer particularly to FIG. 11, the construction of a preferred version of the inner pipe 740 may be understood. A solder passage 742 within the inner pipe allows solder to be delivered from the manifold 438 to the inner nozzle 780. An upper end 744 of the inner pipe is attached to the inner nozzle, while a lower end 746 is attached to the nozzle base 440.

Referring to FIGS. 11 and 12, a lower flange 762 of the outer nozzle enclosure 760 mates with an upper flange 728 of the outer pipe 720. A cylindrical sidewall 764, from which the lower flange extends, has a diameter approximately equal to that of the outer pipe. Referring primarily to FIG. 12, cone-shaped sidewalls 766 carried by an upper portion of the cylindrical sidewall slope radially inwardly. An upper rim of the cone-shaped sidewalls defines a circular heated Nitrogen discharge opening 768, which allows the Nitrogen discharge flow 702 to be exhausted. The heated Nitrogen discharge is directed toward the location to be soldered. The Nitrogen elevates this location's temperature and surrounds it with a non-reactive atmosphere during the soldering operation. These two factors contribute in an important manner to the success of the soldering operation.

Referring to FIG. 12, the structure of the inner nozzle 780 may be understood. The inner nozzle is carried by an upper end of the inner pipe, thereby allowing solder carried by the inner pipe to be discharged by the inner nozzle. The inner nozzle discharges a rounded nipple-shaped wave of solder which remains constant in shape, orientation and size, without flicker or movement. In operation, the robotic elements of the soldering apparatus move the exact portion of the printed circuit board to be soldered into contact with the tip of the solder wave. The Nitrogen discharge 702 heats the area to be soldered, and the tip 705 of the solder wave 704 makes contact with the location to be soldered, leaving the desired solder on the component and printed circuit board.

Continuing to refer to FIGS. 11 and 12, the base 782 defines a shoulder surface 784 through which fasteners 786 or similar structures may be used to attach the inner nozzle to the upper end of the inner pipe. A cylindrical sidewall 788, extending vertically from the base 782, is adjacent to a cone-shaped sidewall 790 oriented with the smaller radius portion of the surface oriented upwardly.

A solder passage 792, defined within the cylindrical sidewall 788, is in communication with the solder carried by the inner pipe. The solder passage is narrowed by restriction 794, which is cone-shaped. A narrow solder discharge channel 796 further restricts the volume of solder flow.

Continuing to refer to FIG. 12, the preferred upper surface configuration of the inner nozzle may be understood. It is this configuration that results in the shape and stability of the solder wave 704. The shape of the wave is important, because the generally rounded point 705 of the wave must be sized for contact with the lead of electronic component to be soldered, without interference with adjacent leads. The stability of the wave is also important, as any “flicker” or movement of the wave could make precise positioning of the tip 705 difficult or impossible. Therefore, while solder is constantly flowing through the wave, the wave is “standing,” i.e. it appears not to move.

The structure in general, and surface configuration in particular, of the upper surface results in the proper shape and stability of the wave 704. The upper surface includes a slight tube extension 798, the inner rim 802 of which defines a discharge port 800 through which the solder is exhausted. A shoulder with a raised outer edge similar to a moat 804 defines an annular depression in the upper surface of the inner nozzle which is concentric to, and surrounding, the inner rim 802. An outer rim 806 is of slightly lower elevation than the inner rim.

Solder flowing out of the discharge port 800 moves upwardly under momentum, forming the solder wave 704 and its upper tip 705. However, gravity pulls the solder downwardly, and into contact with the inner rim 802, the tube extension 798, the moat 804 and outer rim 806. This contact results in a wave 704 that appears to be “frozen,” although it is comprised of moving molten solder.

The previously described versions of the present invention have many advantages, including a primary advantage of providing a novel soldering apparatus for through hole components on a substantially surface mount technology printed circuit board which:

(1) reduces or eliminates the design and lead time required to produce fixtures and tooling required to solder through hole components to a new board design;

(2) eliminates the time and expense of designing and obtaining custom fixtures and nozzles for the flux and soldering of through hole technology components for each individual printed circuit board;

(3) reduces or eliminates the expense associated with the down time resulting from the tooling change-over and set-up of a new nozzle design for each soldering operation;

(4) eliminates the problem and expense of testing the newly configured fixtures, which typically results in permanent damage to a number of printed circuit boards initially sent through the process; and

(5) eliminates large keep away areas between the leads soldered and adjacent SMT components.

A further advantage of the present invention is to provide a novel soldering apparatus for through hole components on a substantially surface mount technology printed circuit board which provides a wave point solder fixture which is able to solder components to a board without the need for a specialized nozzles, fixtures and tooling, and without the need to design, purchase, install and test such fixtures.

Although the present invention has been described in considerable detail and with reference to certain preferred versions, other versions are possible. For example, while in a preferred embodiment of the invention, six lifter and solder pump assemblies are disclosed, in an alternative design a greater or lesser number of these assemblies could be substituted while still in keeping with the teachings of the invention. Therefore, the spirit and scope of the appended claims should not be limited to the description of the preferred versions disclosed.

In compliance with the U.S. Patent Laws, the invention has been described in language more or less specific as to methodical features. The invention is not, however, limited to the specific features described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A soldering apparatus, comprising:
(A) a solder pot assembly to contain a quantity of solder in a liquid state;
(B) a plurality of lifter assemblies;
(C) at least two nozzle support assemblies, carried by each lifter assembly, to supply molten solder from the solder pot assembly through a portion of the at least two nozzle support assemblies in communication with the solder pot assembly; and
(D) a nozzle assembly, carried by a first of the at least two nozzle support assemblies.

2. A soldering apparatus, comprising:
(A) a solder pot assembly to contain a quantity of solder in a liquid state;
(B) a plurality of lifter assemblies;
(C) at least two nozzle support assemblies, carried by each lifter assembly, to supply molten solder from the solder pot assembly through a portion of the at least two nozzle support assemblies in communication with the solder pot assembly;
(D) a nozzle assembly, carried by a first of the at least two nozzle support assemblies; and
(F) a wave point nozzle assembly, carried by a second of the at least two nozzle support assemblies, the wave point nozzle assembly comprising concentrically arrayed, and vertically oriented, outer and inner pipes defining a Nitrogen passage between the pipes, while a solder passage is defined within the inner pipe.

3. A soldering apparatus, comprising:
(A) a wave point nozzle assembly, comprising concentrically arrayed, and vertically oriented, outer and inner pipes defining a Nitrogen passage between the pipes, while a solder passage is defined within the inner pipe.
